(19) United States
(12) Patent Application Publication
(10) Pub. No.: US 2006/0119620 A1
(43) Pub. Date: Jun. 8, 2006

(54) Storage medium storing image display program, image display method and image display apparatus

(75) Inventors: Shinya Taguchi, Shinjuku-ku (JP); Michitoshi Suzuki, Shinjuku-ku (JP); Yutaka Egawa, Shinjuku-ku (JP); Masakazu Ogawa, Shinjuku-ku (JP); Eisuke Kanno, Shinjuku-ku (JP); Shunsuke Nagatani, Shinjuku-ku (JP); Nobuyuki Yamazoe, Shinjuku-ku (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/143,501

(22) Filed: Jun. 3, 2005

(30) Foreign Application Priority Data
Dec. 3, 2004 (JP) 2004-352017

(51) Int. Cl. G09G 5/00

(52) U.S. Cl. 345/629

(57) ABSTRACT

An image display apparatus has a time base display, a time base division unit and a correspondence display. The time base display displays a time base of the dynamic image information. The time base division unit divides the time base by each scene of the dynamic image information associated with the static image information. The correspondence display displays a range on the time base corresponding to the static image information when the static image information is designated. Thus, the image display apparatus displays the correspondence between dynamic image information and static image information associated with the dynamic image information.

### BACKGROUND OF THE INVENTION

(1) Field of the Invention

This invention relates to a storage medium storing an image display program, an image display method and an image display apparatus for displaying the correspondence between dynamic image information such as video images and static image information associated with the dynamic image information.

(2) Description of the Related Art

A system that distributes video contents to a user terminal via a communication network such as the Internet has been used practically.

For example, JP-A-2001-320686 discloses a video content distribution system that can distribute main video information and summary video information to a user terminal via a network and thus enable the user to easily learn the outline of the distributed video content by watching the summary video information.

However, the foregoing reference does not disclose any technique related to handling of static images. The foregoing technique cannot provide measures for the user to understand the relation between dynamic images and static images before watching a content in which dynamic images such as video images and static images such as the associated reference material proceed synchronously.

### SUMMARY OF THE INVENTION

The present invention has been made in view of the above circumstances and provides a storage medium storing an image display program, an image display method and an image display apparatus that enable understanding of the relation between dynamic images and the associated static images before watching contents.

According to an aspect of the present invention, in a storage medium storing an image display program that displays the correspondence between dynamic image information such as video images and static image information associated with the dynamic image information, the image display program causes a computer to execute processing of: displaying a time base of the dynamic image information; dividing the time base by each scene of the dynamic image information associated with the static image information; and displaying a range on the time base corresponding to the static image information when the static image information is designated.

### BRIEF DESCRIPTION OF THE DRAWINGS

Embodiments of the invention will be described in detail based on the following figures, wherein:

FIG. 1 is a block diagram showing a structure of an embodiment of an image display apparatus according to the present invention;

FIG. 2 is a flowchart showing an exemplary operation of the image display apparatus shown in FIG. 1; and

FIG. 3 shows an exemplary display screen that displays static image information and time base.

### DETAILED DESCRIPTION OF THE INVENTION

Hereinafter, the present invention will be described with reference to the drawings.

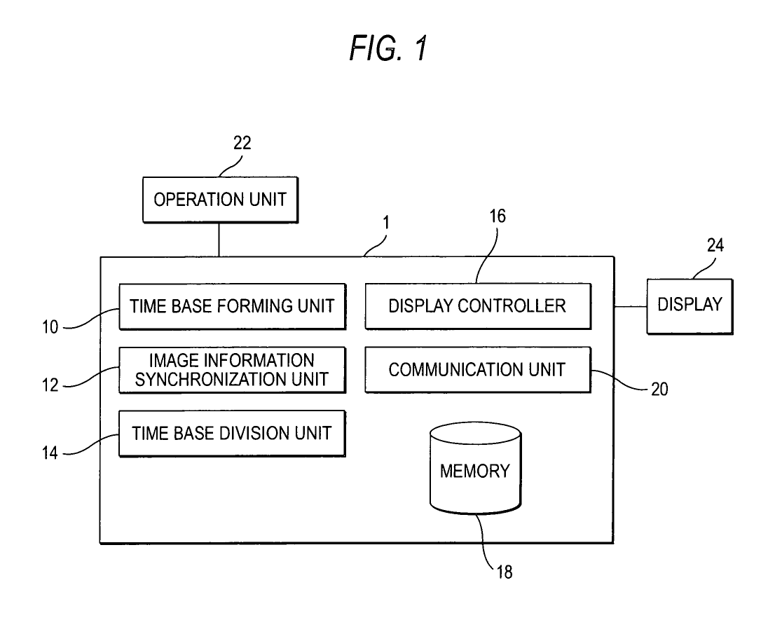

FIG. 1 shows a block diagram of a structure of an embodiment of an image display apparatus according to the present invention. In FIG. 1, an image display apparatus 1 includes a time base forming unit 10, an image information synchronization unit 12, a time base division unit 14, a display controller 16, a memory 18, a communication unit 20, an operation unit 22, and a display 24.

The time base forming unit 10 performs processing to form a time base on the basis of dynamic image information such as video images received via the communication unit 20 or the like. Here, the time base refers to an indication that represents the duration of image of each scene forming the images of dynamic image information, for example, a band-shaped diagram with time scale.

The image information synchronization unit 12 performs processing to synchronize the dynamic image information with the associated static image information such as reference material and make them correspond to each other. Also this static image information can be received via the communication unit 20 or the like.

The time base division unit 14 divides the dynamic image information by each scene corresponding to the static image information and provides information indicating division at a corresponding point on the time base for each division point. Thus, an image time range of each scene of the dynamic image information corresponding to the static image information is recorded on the time base.

The display controller 16 controls display of the dynamic image information, static image information and time base on the display 24.

The memory 18 includes, for example, a work RAM of a CPU, an EEPROM as a non-volatile memory, a magnetic storage medium or the like. Data such as dynamic image information, static image information and time base, and programs are stored in the memory 18.

The communication unit 20 communicates with a server or the like on a communication network by a known technique and executes processing to acquire the above-described dynamic image information, static image information and the like.

The operation unit 22 includes an area designation unit such as a keyboard or mouse. It is used by a user to enter a desired instruction to the image display apparatus.

The display 24 includes, for example, a liquid crystal display or the like and displays the dynamic image information, static image information, time base and the like. If a display screen for displaying the dynamic image information and static image information and a display screen for displaying the static image information and time base are provided separately, understanding of the relation between the dynamic image information and the static image information and browsing of the dynamic image information and the static image information can be separated. Therefore, it is more useful to the user.

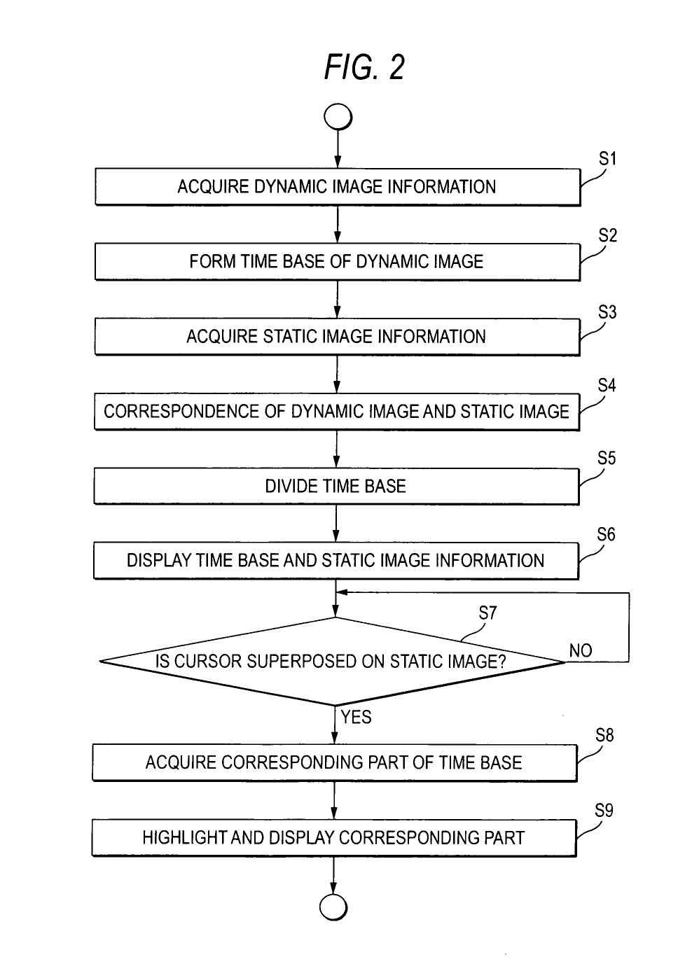

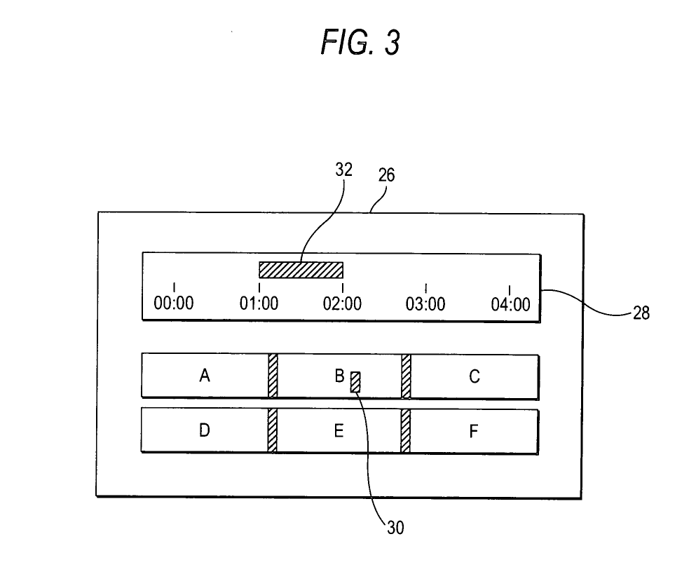

FIG. 2 shows a flowchart of an exemplary operation of the image display apparatus shown in FIG. 1. FIG. 3 shows an exemplary display screen that displays static image information and time base.

In FIG. 2, when dynamic image information such as video images is acquired from a server or the like on the communication network via the communication unit 20 (S1) , the dynamic image information is stored to the memory 18 and the time base forming unit 10 forms a time base based on the dynamic image information (S2). The dynamic image information may be acquired not only from a server on the network but also from a proper medium, for example.

As the communication unit 20 acquires static image information associated with each scene of the dynamic image information together with the dynamic image information or separately from it (S3), the static image information is stored to the memory 18 and the image information synchronization unit 12 performs processing to synchronize the dynamic image information with the associated static image information and to cause the dynamic and static image information to correspond to each other, thus enabling sequential display of the static image information associated with each scene as the images of the dynamic image information proceed (S4). Also this information about the correspondence between the dynamic image information and the static image information is stored to the memory 18. At this point, the image information synchronization unit 12 also performs processing to set the order of the static image information according to the order of the corresponding displayed scenes of the dynamic image information and to store the order to the memory 18. The static image information may be acquired not only from a server on the communication network but also from a proper medium, for example. For executing the processing to display the dynamic image information and the static image information synchronously on the display 24, the display controller 16 receives from the memory 18 the dynamic image information, the static image information and the information about the correspondence between them.

Next, the time base division unit 14 divides the time base by each scene of the dynamic image information corresponding to each static image information on the basis of the synchronization of the dynamic image information with the static image information by the image information synchronization unit 12 (S5). This division is carried out by dividing the dynamic image information by each scene corresponding to the static image information and providing information indicating division at each corresponding point on the time base for each division point, as described above. As the information indicating division, for example, time information at the division point or the like can be used and also this information is stored to the memory 18.

Next, the display controller 16 displays the time base formed by the time base forming unit 10 and the static image information acquired by the communication unit 20 on the display screen of the display 24 that displays the static image information and time base (S6). Here, the time base forming unit 10, the display controller 16 and the display 24 form the time base display according to an aspect of the present invention.

When a cursor is superposed on the display of desired static image information on the display screen by an area designation unit such as a mouse (S7), the display controller 16 acquires a range on the time base corresponding to the static image information (S8) and displays it on the display screen of the display 24 (S9). The display controller 16 and the display 24 in this case form the correspondence display according to an aspect of the present invention.

FIG. 3 shows the state of the display screen in this case. In FIG. 3, a display screen 26 displays a time base 28 and static image information A, B, C, D, E and F. When a cursor 30 is superposed, for example, on the static image information B by the mouse, which forms the operation unit 22, a time range 32 of a scene of dynamic image information corresponding to this static image information B is highlighted and displayed on the time base 28. For highlighting and displaying this time range, the display controller 16 acquires the information indicating the division that is set on the time base 28 by the time base division unit 14, from the memory 18. Thus, the time range from the start of display of the dynamic image information corresponding to the static image information designated by the mouse of the operation unit 22 until the dynamic image information is switched to the dynamic image information corresponding to the next static image information in the order set by the image information synchronization unit 12 is displayed.

By the above-described operation, the user can understand the relation between the dynamic images and the associated static images before watching contents.

In FIG. 3, the display controller 16 may cause a scene of the dynamic image information corresponding to the designated time range 32 to be displayed on the display screen of the display 24 that displays the dynamic image information and static image information, by superposing a cursor on the highlighted and displayed time range 32 on the time base.

The above-described operation of the image display apparatus 1 may be executed by a computer including a CPU as its main component. In this case, each function is realized by the CPU executing a program stored on a memory card or other media.

As described above, some embodiments of the invention are outlined below.

In the storage medium storing an image display program that displays the correspondence between dynamic image information such as video images and static image information associated with the dynamic image information, the image display program causes a computer to execute processes including displaying a time base of the dynamic image information; dividing the time base by each scene of the dynamic image information associated with the static image information; and displaying a range on the time base corresponding to the static image information when the static image information is designated.

The above program may also cause a computer to execute a process including, displaying the dynamic image information corresponding to the range when a range on the time base is designated.

The image display method, according to another aspect of the invention, for displaying the correspondence between dynamic image information such as video images and static image information associated with the dynamic image information includes: displaying a time base of the dynamic image information; dividing the time base by each scene of the dynamic image information associated with the static image information; and displaying a range on the time base corresponding to the static image information when the static image information is designated.

The image display apparatus, according to another aspect of the invention, that displays the correspondence between dynamic image information such as video images and static image information associated with the dynamic image information includes: a time base display that displays a time base of the dynamic image information; a time base division unit that divides the time base by each scene of the dynamic image information associated with the static image information; and a correspondence display that displays a range on the time base corresponding to the static image information when the static image information is designated.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No. 2004-352017 filed on Dec. 3, 2004 including specification, claims, drawings and abstract is incorporated herein by reference in its entirety.

1. A storage medium readable by a computer, the storage medium storing a program of instructions executable by the computer to perform a function for displaying the correspondence between dynamic image information and static image information associated with the dynamic image information, the function comprising:
displaying a time base of dynamic image information;
dividing the time base by each scene of the dynamic image information associated with static image information; and
displaying a range on the time base corresponding to the static image information when the static image information is designated.

2. The storage medium according to claim 1, further comprising: displaying the dynamic image information corresponding to the range when the range on the time base is designated.

3. An image display method for displaying the correspondence between dynamic image information and static image information associated with the dynamic image information, the method comprising:
displaying a time base of the dynamic image information;
dividing the time base by each scene of the dynamic image information associated with the static image information; and
displaying a range on the time base corresponding to the static image information when the static image information is designated.

4. The image display method according to claim 3, further comprising: displaying the dynamic image information corresponding to the range when the range on the time base is designated.

5. An image display apparatus that displays the correspondence between dynamic image information and static image information associated with the dynamic image information, the apparatus comprising:
a time base display that displays a time base of the dynamic image information;
a time base division unit that divides the time base by each scene of the dynamic image information associated with the static image information; and
a correspondence display that displays a range on the time base corresponding to the static image information when the static image information is designated.

6. The image display apparatus according to claim 5 wherein the dynamic information is displayed based on the range when the range on the time base is designated.
